(19) United States
(12) Patent Application Publication
(10) Pub. No.: US 2026/0302901 A1
(43) Pub. Date: Oct. 1, 2026

(54) METHOD AND DEVICE FOR PRODUCING A STATOR BODY OF AN AXIAL FLUX MACHINE, AND AXIAL FLUX MACHINE

(71) Applicant: Schaeffler Technologies AG & Co. KG, Herzogenaurach (DE)

(72) Inventors: Markus Brümmel, Lichtenau (DE); Christian Dinger, Lauf (DE)

(73) Assignee: Schaeffler Technologies AG & Co. KG, Herzogenaurach (DE)

(21) Appl. No.: 19/480,366

(22) PCT Filed: Apr. 22, 2024
(86) PCT No.: PCT/DE2024/100353

§ 371 Date: Oct. 31, 2025

(30) Foreign Application Priority Data
May 2, 2023 (DE) 10 2023 111 189.2

(51) Int. Cl. H02K 15/027; B21D 28/10; B21D 53/00

(52) U.S. Cl. CPC H02K 15/027; B21D 28/10; B21D 53/00

(57) ABSTRACT

A method and device for producing a stator body of an axial flux machine, and the axial flux machine. A punch unit punches out sheet metal portions at defined longitudinal positions from a sheet metal strip. The sheet metal strip has recesses and is rolled up so that its recesses are located at defined angular positions in the roll. Recesses arranged at common angular positions form linear grooves running radially. A recess is generated by a first punch stroke and a second punch stroke so that a first recess boundary edge along the sheet metal strip longitudinal direction is generated with the first punch stroke, a second recess boundary edge along such longitudinal direction is produced with the second punch stroke, and both boundary edges are at a greater distance from one another along the sheet metal strip longitudinal direction than a further sheet metal strip recess.

### CROSS REFERENCE TO RELATED APPLICATIONS

This application is the United States National Phase of PCT Appln. No. PCT/DE2024/100353 filed Apr. 22, 2024, which claims priority to German Application No. DE 10 2023 111 189.2, filed May 2, 2023, the entire disclosures of which are incorporated by reference herein.

### FIELD OF INVENTION

The present disclosure relates to a method and a device for producing a stator body of an axial flux machine. Furthermore, the present disclosure relates to the axial flux machine itself.

### BACKGROUND

Axial flux machines and transverse flux machines are generally known. The special feature of these machines is that they have a circumferential winding that extends concentrically to a shaft of a rotor of the axial flux machine. In this regard, different production processes are known for producing a stator body for axial flux machines.

One method involves winding the stator body from sheet metal. Here, substantially wedge-shaped stator teeth are formed. The winding is to be received in grooves between the stator teeth. For this purpose, the winding is placed in a so-called winding package on the stator teeth and over the grooves and then pushed axially into the grooves. In order to make this possible without causing damage, it is advantageous if the stator teeth have rounded edges so that the stator teeth do not impair the insulation of the winding wires.

Corresponding radii 11 can be seen in FIG. 1 on the stator body 1 shown there on the stator teeth 10. Such radii are often produced by means of milling. However, such a milling process also has disadvantages: individual sheet metal layers are conductively connected to one another due to burr formation, which can lead to greatly increased electromagnetic losses in the stator due to eddy current formation. To avoid this, the stator body has to be etched after milling, which necessitates extensive cleaning. Accordingly, the milling and the post-processing required as a result are time-consuming and costly.

Patent EP 2 722 976 B9 shows an alternative production implementation in which the radius on the stator tooth is approximated by multiple stepped punch-die combinations with a transverse movement with respect to the advancing direction by steps in sheet height during punching.

The specific formation of the stator teeth with radii is explained below. The punch and die are designed for the smallest groove width required, as indicated in FIGS. 2 and 3. FIG. 2 shows a stator body 1 in a top view, and FIG. 3 shows the detail A from FIG. 2 in an enlarged view.

It can be seen here that the stator body 10 is formed by a roll 15 of a thin sheet metal strip, wherein the sheet metal strip has recesses at defined distances, which together form radially running linear grooves 17 at defined angular positions 16.

FIG. 3 shows the radially inner region of some stator teeth 10. On one of the stator teeth 10, individual sheet metal layers 18 are indicated in a radially inner end region in order to illustrate that the stator body 1 is formed by a roll of a rolled-up sheet metal strip. It can also be seen here that the stator teeth 10 have radii 11 on the circumferential boundary edges in order to facilitate the insertion of wire windings and to prevent damage to the wire insulation. In order to form these radii 11, the sheet metal layers 18, which form a respective groove 17 in a region of the radii 11, therefore have recesses of different sizes as adapted windings 14.

It is understood in this context that at least the smallest groove width 12 is implemented, up to the largest groove width 13.

In this regard, patent EP 2 722 976 B9 discloses a device and a method for producing recesses in sheet metal strips from which stator bodies are wound. As described therein, the device uses a plurality of tool inserts with different widths, which can be moved transversely along the advancing direction of the sheet metal strip. Here, the upper punch and lower die arrangements are advanced by an actuator so that relatively wider punches and dies are used to create the first several innermost layers and the last several outermost layers.

However, even with this production method, the effort necessary with respect to production engineering and the investment required to provide the necessary tools are still considerable.

DD 257 335 A5 discloses a method for producing a stator body of an axial flux machine in which two punch strokes are performed in order to produce two separated recesses by means of one punch stroke each.

### SUMMARY

With this background, the present disclosure is based on providing a method and a device for producing a stator body of an axial flux machine as well as an axial flux machine itself, which enable the stator body to be produced in a simple, cost-effective and time-saving manner.

The method for producing a stator body of an axial flux machine is recited according to claim 1 and the device for producing a stator body of an axial flux machine is recited according to claim 11.

Advantageous embodiments of the method are specified in the dependent claims 2 to 10. An axial flux machine according to claim 12 is also provided.

The features of the present disclosure can be combined in any technically meaningful way, wherein it is also possible to make reference for this purpose to the explanations from the following description and features from the figures which include supplementary embodiments of the present disclosure.

In the context of the present disclosure, the terms “radial,” “axial” and “circumferential direction” always refer to the rotation axis of a rotor of the axial flux machine, which is positioned next to the stator body of the axial flux machine.

The present disclosure relates to a method for producing a stator body of an axial flux machine, in which a sheet metal strip and a punch unit are provided and portions of sheet metal are punched out at defined longitudinal positions from the sheet metal strip by means of the punch unit in such a way that the sheet metal strip has recesses. The sheet metal strip having recesses is rolled up in such a way that the recesses are located at defined angular positions in the roll of the sheet metal strip and recesses arranged at common angular positions form linear grooves running in the radial direction. In this regard, at least one recess is created by a first punch stroke and a second punch stroke in such a way that a first boundary edge defining the recess along the longitudinal direction of the sheet metal strip is created with the first punch stroke, a second boundary edge defining the recess along the longitudinal direction of the sheet metal strip is created with the second punch stroke, and both boundary edges are at a greater distance from one another along the longitudinal direction of the sheet metal strip than at least one further recess in the sheet metal strip.

Due to the arbitrary formation of a width of the at least one recess, i.e., the distance between the two boundary edges of the at least one recess, there is an advantage that a course of a groove edge of the linear grooves running in the radial direction can be freely selected as desired.

After the recesses have been created, the sheet metal strip further comprises a strip of material running in the longitudinal direction, from which individual webs separate the recesses from one another.

In an advantageous embodiment of the method described, multiple recesses are created by two punch strokes so that these recesses receive a larger size or extension with respect to the longitudinal direction of the sheet metal strip.

A larger size or extension with respect to the longitudinal direction of the sheet metal strip of a larger recess refers in relation to a smaller recess which, in the rolled-up state of the sheet metal strip, is located at the same angular position as the larger recess, so that the smaller recess and the larger recess together form a stepped groove.

The stator is essentially completed by arranging windings in the grooves of the stator body.

Advantageously, the first punch stroke and the second punch stroke are applied to the same recess and a width of the same recess can be changed by changing a position of the first boundary edge created by means of the first punch stroke along the longitudinal direction of the sheet metal strip and/or by changing a position of the second boundary edge created by means of the second punch stroke along the longitudinal direction of the sheet metal strip.

Advantageously, the position of the first boundary edge and/or the position of the second boundary edge can be changed in such a way that any desired shape contours of the same recess can be created.

The first punch stroke and the second punch stroke can be carried out with the same punch, wherein after the first punch stroke has been carried out, a relative advancing movement is carried out between the sheet metal strip and the punch unit, and then the second punch stroke is carried out. A wider or larger recess is created accordingly in that the first punch stroke and the second punch stroke are performed with the same punch at different longitudinal positions of the sheet metal strip, wherein the overcut regions of the first punch stroke and the second punch stroke at least partially overlap one another. This overcut region or overlap region varies depending on the desired groove width.

The relative advancing movement between the sheet metal strip and the punch unit can be carried out by a rotation of the rolled-up roll of the sheet metal strip.

Alternatively or additionally, the relative advancing movement between the sheet metal strip and the punch unit can be carried out by a translational relative movement between the rolled-up roll of the sheet metal strip and the punch unit. The roll can therefore be moved translationally and/or the punch unit can be moved translationally, possibly in combination with the rolled-up roll of the sheet metal strip.

The translational relative movement can be realized, for example, by means of a linear unit that displaces the rolled-up roll in a translational manner.

A further alternative embodiment of the method provides for the first punch stroke to be carried out with a first punch and the second punch stroke to be carried out with a second punch and for a relative movement between the first punch and the second punch to be carried out to produce multiple recesses of different sizes for each recess. In this case, the punch unit has two punches.

Both punches are arranged offset with respect to one another along the longitudinal direction of the sheet metal strip in order to create the two boundary edges.

In order to determine the positions of the boundary edges, the method can be carried out in such a way that the target size Ga of the recess to be punched out along the longitudinal direction of the sheet metal strip is determined before the first punch stroke is performed. The difference D from the target size Ga to the size Wb of an adjacent recess can then be determined, which is located at the same angular position in the radially inner adjacent winding of the roll of the sheet metal strip. In addition, a theoretical distance A can be determined which is dependent on a number of linear grooves running in the radial direction and/or a current position of the rolled-up sheet metal strip and/or a sheet metal thickness of the sheet metal strip and which would result without enlarging the recess along the longitudinal direction of the sheet metal strip with respect to the adjacent recess. From this—starting from the first boundary edge of a previously created recess adjacent along the longitudinal direction of the sheet metal strip—a distance Sv of an advancing movement of the sheet metal strip can be determined, which results from:

$$Sv = A + Wb - D / 2 .$$

The first punch stroke can be performed at the position on the sheet metal strip resulting from the advancing movement of the sheet metal strip with the distance Sv.

By determining the target size Ga of the recess to be punched out, the radius at the groove is adjusted by stepping the edges of multiple sheet metal layers rolled on top of one another in an angular position. The theoretical distance A, which would result without enlarging the recess along the longitudinal direction of the sheet metal strip with respect to the adjacent recess, depends on the radial position of the relevant recess in the roll.

Before the second punch stroke is performed, a position of the second boundary edge can be determined with respect to a position of the first boundary edge by adding the target size Ga of the recess to a position dimension of the first boundary edge. The second punch stroke can be performed at this position to produce the second boundary edge.

Alternatively, or as a verifying calculation, the term Wb+D/2 can also be added to the position dimension of the first boundary edge. Here, the distance is defined from the roll.

Accordingly, the recess is widened symmetrically. However, an asymmetrical execution of the recess widening is not to be excluded from the present disclosure.

This asymmetrical execution of the recess widening can be achieved as follows, for example. The position for each punch stroke can be freely selected by moving the rotational axis or the translational movement through the linear axis. It is therefore possible to design the width of a groove created from two punch strokes in such a way that an asymmetrical ratio around the center axis of the grooves results. As a logical consequence, it is also possible to design the course of the groove edge, which is created by lining up individual layers selected separately in a geometry, as desired. The different design of the grooves in their course is particularly useful here in order to realize specific poka-yoke features for downstream assembly processes.

Distances between adjacent recesses for forming linear radially extending grooves can be adapted by a translational relative movement between the roll and the punch unit.

For example, the roll created is moved linearly in relation to the punch unit, in particular away from it. The roll created by the wound sheet metal strip should have linear radially running grooves formed by the recesses radially overlapping one another. However, this means that distances between recesses adjacent to one another along the circumferential direction in a section of the sheet metal strip located radially further inside the roll is created much closer together than distances between recesses adjacent to one another along the circumferential direction that are arranged radially further outside in the roll.

Accordingly, care is taken to ensure that the distances between adjacent recesses become ever greater during the rolling up and punching process. This increase in distance can be achieved by a translational relative movement between the roll and the punch unit, for example by a linear unit that moves the roll in relation to the punch unit.

A further aspect of the present disclosure is a device for producing a stator body of an axial flux machine, which has a punch unit for punching recesses out of a sheet metal strip at defined longitudinal positions and a rolling device for rolling up the sheet metal strip having the recesses in such a way that the recesses are located at defined angular positions in the roll of the sheet metal strip and recesses arranged at common angular positions form linear grooves running in the radial direction. The punch unit is configured to create at least one recess by a first punch stroke and a second punch stroke in such a way that a first boundary edge defining the recess along a longitudinal direction of the sheet metal strip is created with the first punch stroke, a second boundary edge defining the recess along the longitudinal direction of the sheet metal strip is created with the second punch stroke, and both boundary edges are at a greater distance from one another along the longitudinal direction of the sheet metal strip than at least one further recess in the sheet metal strip.

The device can also have a linear device with which the distance between the recesses can be adapted and/or expansions of the size of a respective recess can be adjusted.

A corresponding control device for controlling the individual units of the device, including the linear device, can be provided. The control device can also be configured to control the rolling device in such a way that the expansions of the size of a respective recess can be adjusted.

In addition, according to the present disclosure, an axial flux machine is provided which has a stator body produced according to the present disclosure.

The present disclosure described above is explained in detail below against the relevant technical background with reference to the associated drawings, which show exemplary embodiments. The present disclosure is in no way limited by the purely schematic drawings, wherein it should be noted that the exemplary embodiments shown in the drawings are not limited to the dimensions shown.

### BRIEF DESCRIPTION OF THE DRAWINGS

In the drawings:

FIG. 1 shows a stator body of an axial flux machine in a perspective view,

FIG. 2 shows a stator body of an axial flux machine in a top view with the detail A,

FIG. 3 shows the detail A from FIG. 2 in an enlarged view,

FIG. 4 shows the structure of a device for carrying out the method for producing the stator body of an axial flux machine,

FIG. 5 shows a sheet metal strip while performing a first punch stroke,

FIG. 6 shows the sheet metal strip between two punch strokes, and

FIG. 7 shows the sheet metal strip while performing a second punch stroke.

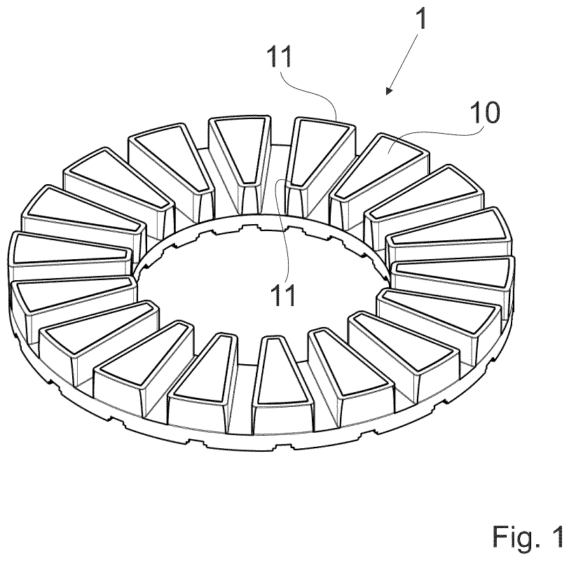

FIGS. 1 to 3 have already been referred to in order to explain the prior art.

### DETAILED DESCRIPTION

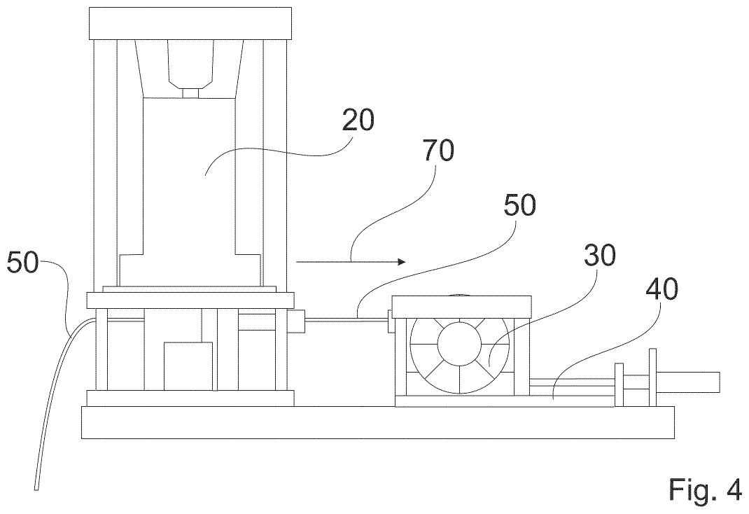

FIGS. 4 to 7 show, on the basis of the tools used and the individual punch strokes, the sequence of the method according to the present disclosure in order to produce a stator body as shown in FIGS. 1 to 3.

The features of the stator body itself mentioned below thus refer to FIGS. 1 to 3.

FIG. 4 shows the basic structure of the device for producing a stator body of an axial flux machine.

The device comprises a punch unit 20 with one or more punches for creating recesses in a sheet metal strip 50, a rolling device 30 for rolling up the sheet metal strip 50 provided with recesses, and a linear unit 40 for varying a distance between the rolling device 30 or the roll held thereby and the punch unit 20.

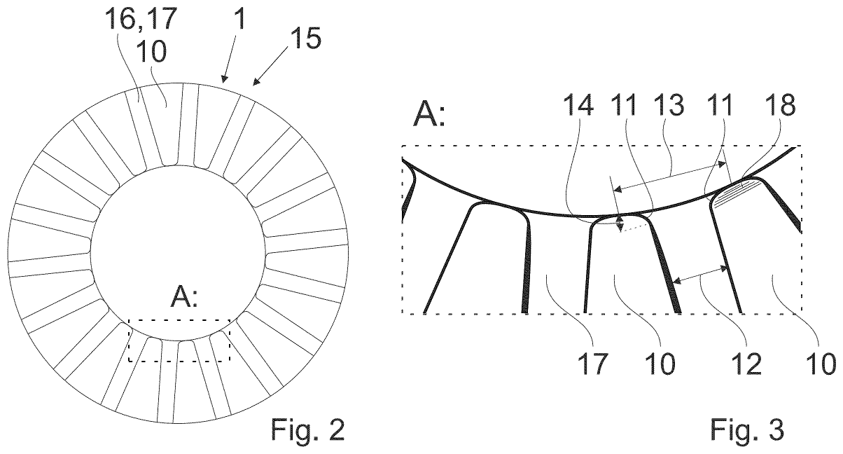

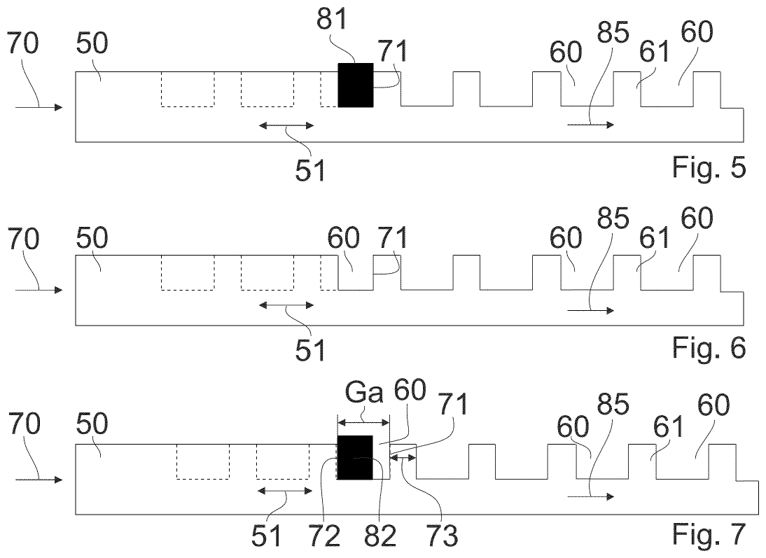

In the production method, the sheet metal strip 50 is picked up by a reel not shown here and supplied in stretched form to the punch unit 20 along an advancing direction 70. The punch unit 20 is used to create recesses in the sheet metal strip 50, as described on the basis of FIGS. 5 to 7. After the sheet metal strip 50 has been processed by the punch unit 20, the sheet metal strip 50 is supplied to the rolling device 30. This rolling device 30 sits on a carriage of a linear unit 40, using which the distance between the rolling device 30 and the punch unit 20 can be adjusted. This is due to the fact that there is a number of grooves already punched between the punching point or position of the punch unit 20 and the winding point defined by the machine design and the angular rotation of the rotational axis of the rolling device 30 is suitable for the groove located directly at the winding point. Accordingly, a change in the advancing length per groove up to the punching point is carried out by the movement of the linear unit 40 in order to adapt the distances between the recesses in such a way that they can together form the linear grooves 17 in the stator body 10 in different radial positions, see FIG. 2.

The punching processes are explained on the basis of FIGS. 5 to 7.

FIG. 5 shows a top view of the sheet metal strip 50 while performing a first punch stroke. FIG. 6 shows the sheet metal strip 50 in a top view between the two punch strokes, and FIG. 7 shows the sheet metal strip 50 in a top view when the second punch stroke is performed.

In order to prepare for the first punch stroke according to FIG. 5, the rolling device 30 rotates and thereby moves the sheet metal strip 50 along the advancing direction 70.

Prior to performing the first punch stroke 81, the target size Ga of the recess 60 to be punched out along the longitudinal direction 51 of the sheet metal strip 50 is determined. Furthermore, a difference D from the target size Ga to a size Wb of an adjacent recess is determined, which is located at the same angular position in the radially inner adjacent winding of the roll of the sheet metal strip. In addition, a theoretical distance A is determined, which would result without enlarging the recess along the longitudinal direction of the sheet metal strip with respect to the adjacent recess.

The distance Sv of an advancing movement of the sheet metal strip 50 is calculated with

$$Sv = A + W b - D / 2$$

An advancing movement with this distance Sv is carried out, and the first punch stroke 81 for producing the first boundary edge 71 is performed at this position.

FIG. 6 shows the sheet metal strip 50 with the first boundary edge 71 created.

A relative advancing movement 85 is then carried out between the sheet metal strip 50 and the punch unit 20 in order to produce the second boundary edge 72, as shown in FIG. 7.

The advancing value of the relative advancing movement 85 is the complete value of the target size Ga of the recess 60 to be produced and thus the necessary expansion of the groove width in order to produce part of the radius.

This ensures that the expansion of the groove width or the width of the recess 60 is symmetrical about the center line of the groove.

The second punch stroke 82 is performed for the same recess 60.

Depending on the selected target size Ga of the recess 60 in question, the overcut region in a groove base varies in size.

In this regard, the relative advancing movement 85 can be performed by actuation of the rolling device 30 and/or the linear unit 40, as shown in FIG. 4.

The adaptation of the advancing movement of the sheet metal strip 50 along the advancing direction 70, in order to adapt the positions of the recesses 60 along the longitudinal direction 51 of the sheet metal strip 50 to the angular positions dependent on the radial positions of the recesses in the stator body, can be carried out by actuation of the rolling device 30 alone. As a result, the webs 61 between the recesses 60 are also adapted and, accordingly, the distances 73 are progressively increased in the ongoing punching process.

By gradually increasing the target sizes Ga of the recesses 60, a radius 11 can be created in a targeted manner by a step-wise approach after the sheet metal strip 50 has been rolled up, as indicated in FIG. 3.

With the method shown, for example, a stator body 10 with 18 grooves 17 can be created, which thus has a nominal pitch of 20°. The center lines of the grooves 17 are thus offset by 20°. In order to create a wider groove 17, an angle of 19.5° is rotated in a first step. This is followed by the first punch stroke 81. The rolling device 30 now turns to 20.5°. This is followed by the second punch stroke 82. Depending on the radial position of the created recess 60 in the punch body 10, the modification of the angle of rotation in degrees results in a change in the groove width in millimeters.

The method and device proposed here for producing a stator body of an axial flux machine and the axial flux machine itself provide solutions that enable the stator body to be produced in a simple, cost-effective and time-saving manner.

### LIST OF REFERENCE SIGNS

1 Stator body
10 Stator tooth
11 Radius
12 Smallest groove width
13 Largest groove width
14 Adapted winding
15 Roll
16 Angular position
17 Groove
18 Sheet metal layer
20 Punch unit
30 Rolling device
40 Linear unit
50 Sheet metal strip
51 Longitudinal direction
60 Recess
61 Web
70 Advancing direction
71 First boundary edge
72 Second boundary edge
73 Distance
81 First punch stroke
82 Second punch stroke
85 Relative advancing movement
Ga Size

1. A method for producing a stator body of an axial flux machine, wherein the method comprises:
providing a sheet metal strip and a punch unit,
punching out portions of sheet metal at defined longitudinal positions from the sheet metal strip by the punch unit in such a way that the sheet metal strip has recesses, and
rolling up the sheet metal strip having the recesses in such a way that the recesses are located at defined angular positions in the roll of the sheet metal strip and recesses arranged at common angular positions form linear grooves running in a radial direction, wherein
at least one recess is created by a first punch stroke and a second punch stroke in such a way that a first boundary edge defining the at least one recess along a longitudinal direction of the sheet metal strip is created with the first punch stroke, a second boundary edge defining the at least one recess along the longitudinal direction of the sheet metal strip is created with the second punch stroke, and both the first and second boundary edges are at a greater distance from one another along the longitudinal direction of the sheet metal strip than at least one further recess in the sheet metal strip.

2. The method according to claim 1, wherein the first punch stroke and the second punch stroke are applied to the same at least one recess and a width of the same at least one recess is changed by at least one of changing a position of the first boundary edge created by the first punch stroke along the longitudinal direction of the sheet metal strip or by changing a position of the second boundary edge created by the second punch stroke along the longitudinal direction of the sheet metal strip.

3. The method according to claim 2, wherein at least one of the position of the first boundary edge or the position of the second boundary edge is changed in such a way that any desired shape contours of the same at least one recess can be created.

4. The method according to claim 1, wherein the first punch stroke and the second punch stroke are carried out with the same punch and, after the first punch stroke has been carried out, a relative advancing movement is carried out between the sheet metal strip and the punch unit before the second punch stroke is carried out.

5. The method according to claim 4, wherein the relative advancing movement between the sheet metal strip and the punch unit is carried out by rotating the rolled-up roll of the sheet metal strip.

6. The method according to claim 4, wherein the relative advancing movement between the sheet metal strip and the punch unit is carried out by translating relative movement between the rolled-up roll of the sheet metal strip and the punch unit.

7. The method according to claim 1, wherein the first punch stroke is carried out with a first punch and the second punch stroke is carried out with a second punch, and relative movement between the first punch and the second punch is carried out to produce recesses of different sizes.

8. The method according to claim 1, wherein
a target size Ga of a recess to be punched out is determined before the first punch stroke is performed,
a difference from the target size Ga to a size Wb of an adjacent recess is determined, which is located at the same angular position in a radially inner adjacent winding of the roll of the sheet metal strip,
a theoretical distance A is determined which is dependent on at least one of a number of linear grooves running in the radial direction, a current radial position of the rolled-up sheet metal strip, or a sheet metal thickness of the sheet metal strip and which would result without enlarging the recess along the longitudinal direction of the sheet metal strip with respect to the adjacent recess,
an advancing movement of the sheet metal strip is performed with a distance Sv which results from
$$Sv = A + W b - D / 2 ,$$
the first punch stroke is performed at the position on the sheet metal strip resulting from the advancing movement of the sheet metal strip with the distance Sv.

9. The method according to claim 8, wherein
before the second punch stroke is performed, a position of the second boundary edge is determined with respect to a position of the first boundary edge by adding the target size Ga to a positional dimension of the first boundary edge, and
the second punch stroke is performed at the determined position of the second boundary edge.

10. The method according to claim 1, distances between adjacent recesses for forming linear radially extending grooves are adapted by a translational relative movement between the roll and the punch unit.

11. A device for producing a stator body of an axial flux machine, the device comprising:
a punching tool for punching recesses out of a sheet metal strip at defined longitudinal positions,
a rolling device for rolling up the sheet metal strip having the recesses in such a way that the recesses are located at defined angular positions in the roll of the sheet metal strip and recesses arranged at common angular positions form linear grooves running in the radial direction,
wherein the punch unit is configured to create at least one recess by a first punch stroke and a second punch stroke in such a way that a first boundary edge defining the at least one recess along a longitudinal direction of the sheet metal strip is created with the first punch stroke, a second boundary edge defining the at least one recess along the longitudinal direction of the sheet metal strip is created with the second punch stroke, and the first and second boundary edges are at a greater distance from one another along the longitudinal direction of the sheet metal strip than at least one further recess in the sheet metal strip.

12. An axial flux machine having a stator body produced according to the method of claim 1.

13. The device according to claim 11, wherein the punching tool includes an input which receives the sheet metal strip and an output which provides the sheet metal strip with the recesses to an input of the rolling device.

14. The device according to claim 11, wherein the rolling device includes an input for receiving, from an output of the punching tool, the sheet metal strip having recesses punched by the punching tool.

15. The device according to claim 14, wherein the rolling device is disposed on an adjustable carriage in which a position of the rolling device relative to the punching tool is adjustable.
